(19) United States
(12) Patent Application Publication
(10) Pub. No.: US 2025/0233180 A1
(43) Pub. Date: Jul. 17, 2025

(54) METHOD FOR COOLING A FUEL CELL STACK, CONTROL DEVICE

(71) Applicant: Robert Bosch GmbH, Stuttgart (DE)

(72) Inventors: Andreas Gleiter, Stuttgart (DE); Bernhard Zickgraf, Neckarsulm (DE); Marie-Dominique Fischer, Fellbach (DE); Martin Brandt, Sachsenheim (DE); Saskia Bostelmann, Stuttgart (DE); Sebastian Nuber, Stuttgart (DE); Shaofei Chen, Ditzingen (DE); Thomas Demmer, Stuttgart (DE)

(21) Appl. No.: 18/854,697

(22) PCT Filed: Mar. 31, 2023
(86) PCT No.: PCT/EP2023/058503

§ 371 Date: Oct. 7, 2024

(30) Foreign Application Priority Data
Apr. 8, 2022 (DE) 10 2022 203 575.5

(51) Int. Cl. H01M 8/04746; H01M 8/04007

(52) U.S. Cl. CPC H01M 8/04768; H01M 8/04007

(57) ABSTRACT

The invention relates to a method for cooling a fuel cell stack (2) of a preferably mobile fuel cell system (1) with the aid of a cooling circuit (3) conducting a coolant, into which a pump (4), a radiator (5) having a fan (6), and a directional control valve (7) for opening and closing a bypass (8) for circumventing the radiator (5) are integrated, wherein the temperature of the coolant is adjusted to a predefined normal value or normal range via the mixing proportion of the coolant fluxes conducted through the radiator (5) and/or the bypass (8) as well as via the air velocity at the radiator (5), According to the invention, the temperature of the coolant varies as a function of the current cooling capacity of the cooling circuit (3) and/or the current energy consumption of the cooling circuit (3) and is lowered or raised compared to the normal value or normal range.

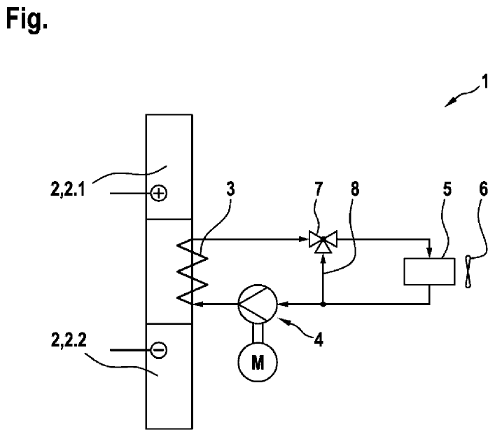

The invention furthermore relates to a control device for carrying out steps of the method.

### BACKGROUND

The present invention relates to a method for cooling a fuel cell stack of a preferably mobile fuel cell system according to the disclosure.

The cooling of a fuel cell stack of a fuel cell system can be implemented with a cooling system comprising a pump and a radiator having a fan. In mobile applications, that is to say in a vehicle, the radiator is typically the vehicle cooler.

DE 10 2016 213 533 A1 discloses for example a cooling system for temperature control of a fuel cell system comprising a closed cooling line for a coolant. A pump for adjusting the pressure in the cooling line is integrated into the cooling line. With the aid of the pump, the coolant is supplied to the fuel cell system to be cooled. There, the coolant absorbs the process heat of the fuel cell system. After passing through the fuel cell system, the coolant is supplied to a radiator, for example a vehicle cooler, where it is cooled again with the aid of a fan.

In addition, cooling systems having cooling circuits are known, which comprise a bypass for circumventing the cooler or radiator. With the aid of a directional control valve, the mixing proportion of the coolant fluxes conducted through the radiator and the bypass can be adjusted. Typically, a fixed target temperature of the coolant is set via the regulation of the directional control valve in combination with control of the fan.

The temperature of the coolant influences the aging and thus the efficiency of the fuel cell stack over its service life. Because a low temperature positively affects the efficiency of the fuel cell stack, it can be advantageous to set a low coolant temperature as the fixed target temperature. However, this results in a low temperature difference at the radiator compared to the environment. This can result in the cooling capacity of the cooling system being exceeded or the cooling system being operated in a threshold range in which the energy consumption is increased, because the required cooling capacity is only achieved by increasing the coolant flux or air flux at the radiator.

### SUMMARY

The present invention addresses the problem of optimizing the cooling of a fuel cell stack to the effect that the efficiency of the fuel cell stack is increased with simultaneously low energy costs for the cooling.

A method is proposed for cooling a fuel cell stack of a preferably mobile fuel cell system with the aid of a cooling circuit conducting a coolant, into which a pump, a radiator having a fan, and a directional control valve for opening and closing a bypass for circumventing the radiator are integrated. The temperature of the coolant is adjusted to a predefined normal value or normal range via the mixing proportion of the coolant fluxes conducted through the radiator and/or the bypass as well as via the air velocity at the radiator. According to the invention, the temperature of the coolant varies as a function of the current cooling capacity of the cooling circuit and/or the current energy consumption of the cooling circuit and is lowered or raised compared to the normal value or normal range.

Accordingly, in the proposed method, a fixed target value for the temperature of the coolant is not specified, but rather the coolant temperature is varied. In so doing, starting from a predefined normal value or normal range, the temperature of the coolant is lowered or raised. Decisive for lowering or raising the temperature is/are the current energy and/or energy consumption of the cooling circuit. Keeping in mind these two parameters, the temperature of the coolant can be kept as low as possible in order to thereby increase the efficiency of the fuel cell stack.

The proposed variation in the temperature of the coolant therefore allows the temperature to be optimally adapted to the current conditions, so that an increase in efficiency can be achieved even without increased energy consumption.

In the proposed method, a normal range for the temperature of the coolant is preferably first defined. This can be 62-68° C., for example. If a temperature value that serves as the lower limit of the normal range is exceeded, the operation of the cooling circuit takes place in a lowered temperature range. If a temperature value that serves as the upper limit for the normal range is exceeded, the operation of the cooling circuit takes place in a raised temperature range. Establishing a normal range instead of a single normal value allows for greater flexibility in design.

Preferably, the temperature of the coolant is lowered compared to the normal value or normal range when
(i) an excess of the cooling capacity of the cooling circuit is reliably prevented, and
(ii) the energy consumption of the cooling circuit can be kept below a predefined threshold.

Accordingly, the lowering of the coolant temperature is linked to conditions. Only when these conditions are met can the temperature be lowered in order to increase efficiency of the fuel cell stack. In this way, not only is an excess of the cooling capacity of the cooling circuit avoided, but at the same time, an increased energy consumption of the cooling circuit, in particular the pump and the fan of the cooling circuit, is avoided.

The energy consumption is preferably determined based on the current ambient temperature and/or the current air velocity at the radiator, wherein the determination is preferably based on an estimate. That is to say, the energy consumption is preferably estimated. Because in mobile applications the air velocity at the radiator is dependent on the vehicle velocity, this too can be used as the basis for the estimate.

Furthermore, the temperature of the coolant is preferably raised compared to the normal value or normal range when
(i) there is a threat of an excess of the cooling capacity of the cooling circuit, and
(ii) the operating temperature of the fuel cell stack can be kept below a maximum permissible limit.

The raising of the coolant temperature is thus also linked to conditions. Only when these conditions are met can the temperature be raised above the normal value or the normal range. Compliance with the conditions ensures that neither the cooling capacity of the cooling circuit nor the maximum permissible operating temperature of the fuel cell stack is exceeded.

Furthermore, it is proposed that, in the case of a raised temperature of the coolant, the operation of the cooling circuit is ended when it is ensured that the cooling capacity of the cooling circuit is sufficient for operation at a temperature of the coolant corresponding to the normal value or normal range. That is to say, as soon as the cooling capacity of the cooling circuit allows it, the temperature of the coolant is lowered again in order to increase the efficiency of the fuel cell stack. This requires the lowest possible coolant temperature.

Advantageously, the operation of the cooling circuit at an increased temperature is limited in time. The temporal limit can be carried out per event and/or over the entire service life of the fuel cell stack. That is to say, the amount of each individual increase and/or all increases is limited in time. If the temporal limit is exceeded, an increase in the coolant temperature is no longer permissible. If necessary, a reduction of the output of the fuel cell stack is then required in order to reduce the cooling capacity of the cooling circuit to the maximum possible cooling capacity.

In addition, a control device that is configured so as to carry out steps of a method according to the invention is proposed. For example, with the aid of the control device, a control or regulation of the directional control valve and/or fan integrated into the cooling circuit can be implemented in order to lower or raise the temperature of the coolant.

### BRIEF DESCRIPTION OF THE DRAWING

The invention and its advantages are explained in further detail below with reference to the accompanying drawing. It shows a schematic representation of a fuel cell stack of a fuel cell system connected to a cooling circuit.

### DETAILED DESCRIPTION

The illustrated fuel cell stack 2 of a fuel cell system 1 comprises an anode 2.1 and a cathode 2.2. During operation of the fuel cell system 1, the anode 2.1 is supplied with hydrogen via an anode circuit (not shown). The cathode 2.2 is supplied with ambient air as an oxygen supplier via an inlet air path (not shown). Hydrogen and oxygen are converted into electrical energy and water in the fuel cells of the fuel cell stack 2.

The heat generated during this process is dissipated via a cooling circuit 3, which is conducted in sections through the fuel cell stack 2. Outside the fuel cell stack 2, a pump 4, a radiator 5 having a fan 6, and a directional control valve 7 are integrated into the cooling circuit 3. With the aid of the pump 4, a coolant is circulated in the cooling circuit 3. When the coolant reaches the fuel cell stack 2, it absorbs heat, which it then releases to the environment with the aid of the radiator 5 and the fan 6. With the aid of the directional control valve 7, the coolant flux conducted via the radiator 5 can be controlled. This is because, depending on the switch position of the directional control valve 7, at least a partial flux of the coolant is not supplied to the radiator 5 but is rather branched off into a bypass 8 that circumvents the radiator 5. That is to say, the coolant can release less heat to the environment. The temperature of the coolant can therefore be adjusted via the mixing proportion of the coolant fluxes conducted through the radiator 5 and the bypass 8. Furthermore, the air velocity on the radiator 5 has an influence on the coolant temperature. This can be influenced by the operation of the fan 6. In mobile applications, the air velocity also depends on the velocity of the vehicle.

Because a low coolant temperature in operation of the fuel cell system 1 has a positive effect on the aging and thus the efficiency of the fuel cell stack 2, as low a coolant temperature as possible is sought. However, this results in a low temperature difference at the radiator 5 compared to the environment. If the ambient temperature is sufficiently low, it can be assumed that the heat absorbed by the coolant can also be released without a significant increase in the energy required for the heat dissipation. However, it is generally true that, in order to be able to achieve the same cooling capacity, the coolant and/or air flux at the radiator 5 must be increased. That is to say, the output of the pump 4 and/or the fan 6 must be increased, which leads to an increase in the energy consumption of the cooling circuit 3.

An increased coolant temperature, in turn, results in a higher temperature difference at the radiator 5 compared to the ambient environment, such that, with the same coolant and air flux at the radiator 5, a higher cooling capacity can be achieved. However, in order to increase the efficiency of the fuel cell stack 2, an increased coolant temperature is less desirable.

In order to solve this conflict of goals, the method according to the invention proposes a variable adjustment of the coolant temperature. The adjustment is made depending on the current cooling capacity and/or the current energy consumption of the cooling circuit 3, in particular of the pump 4 integrated into the cooling circuit 3 as well as of the fan 6 integrated into the cooling circuit 3.

According to the method according to the invention, the coolant temperature is lowered or raised compared to a predefined normal value or normal range. The lowering or raising of the coolant temperature is linked to certain conditions.

A lowering of the coolant temperature compared to the normal value or the normal range is only possible when it is ensured that the cooling capacity, i.e., a maximum permissible cooling capacity of the cooling circuit 3, is not exceeded and the energy consumption remains below a predefined threshold. Because this mode of operation results in an increase in the efficiency of the fuel cell stack 2, it is preferably selected, provided that the two conditions set forth above are met.

A raising of the coolant temperature compared to the normal value or the normal range is only permissible when the cooling capacity of the cooling circuit 3 is no longer sufficient, such that the cooling capacity of the cooling circuit 3 is threatened, and it is also ensured that a maximum permissible operating temperature of the fuel cell stack 2 is not exceeded.

The method according to the invention allows the operating strategy to be designed such that the fuel cell system 1 is operated as often as possible at low coolant temperatures. However, if this results in a significant increase in energy consumption and/or operation of the cooling circuit 3 in the threshold range, such that there is a risk of exceeding the cooling capacity of the cooling circuit 3, the coolant temperature can be raised. By raising the temperature, the energy consumption is lowered and an excess of the cooling capacity of the cooling circuit 3 is safely avoided.

1. A method for cooling a fuel cell stack (2) of a mobile fuel cell system (1) with the aid of a cooling circuit (3) conducting a coolant, into which a pump (4), a radiator (5) having a fan (6), and a directional control valve (7) for opening and closing a bypass (8) for circumventing the radiator (5) are integrated, wherein the temperature of the coolant is adjusted via an electronic controller to a predefined normal value or normal range via a mixing proportion of the coolant fluxes conducted through the radiator (5) and/or the bypass (8) as well as via the air velocity at the radiator (5),
wherein the temperature of the coolant varies as a function of the current cooling capacity of the cooling circuit (3) and/or the current energy consumption of the cooling circuit (3) and is lowered or raised compared to the normal value or normal range.

2. The method according to claim 1,
wherein the temperature of the coolant is lowered compared to the normal value or normal range is lowered when
(i) an excess of the cooling capacity of the cooling circuit (3) is reliably prevented, and
(ii) the energy consumption of the cooling circuit (3) can be kept below a predefined threshold.

3. The method according to claim 1,
wherein the energy consumption is determined based on the current ambient temperature and/or the current air velocity at the radiator (5).

4. The method according to claim 1,
wherein the temperature of the coolant is raised compared to the normal value or normal range when
(i) there is a threat of an excess of the cooling capacity of the cooling circuit (3), and
(ii) the operating temperature of the fuel cell stack (2) can be kept below a maximum permissible limit.

5. The method according to claim 1,
wherein, in the case of a raised temperature of the coolant, the operation of the cooling circuit (3) is ended when it is ensured that the cooling capacity of the cooling circuit (3) is sufficient for operation at a temperature of the coolant corresponding to the normal value or normal range.

6. The method according to claim 1,
wherein, in the case of a raised temperature, the operation of the cooling circuit (3) is limited in time, for example per event and/or over the entire service life of the fuel cell stack (2).

7. (canceled)
